(19) United States
(12) Patent Application Publication
(10) Pub. No.: US 2026/0123582 A1
(43) Pub. Date: May 7, 2026

(54) NON-CONTACT CROP MOISTURE SENSOR FOR A SUGARCANE HARVESTER

(71) Applicant: Deere & Company, Moline, IL (US)

(72) Inventors: Michael L. Halbrook, Thibodaux, LA (US); Kerry J. Morvant, Thibodaux, LA (US)

(21) Appl. No.: 18/935,855

(22) Filed: Nov. 4, 2024

(51) Int. Cl. A01D 45/10; A01D 43/08

(52) U.S. Cl. CPC A01D 45/10; A01D 43/085

(57) ABSTRACT

A sugarcane harvester includes a cutter assembly for cutting stalks of the sugarcane as the harvester moves through a field. A chopper assembly is provided for chopping the cut sugarcane stalks into billets and crop residue. A primary extractor is provided for cleaning the billets and extracting the crop residue. A loading elevator transports the cleaned billets to a discharge location. At least one moisture sensor is configured to sense a moisture content of the billets as the billets move through the sugarcane harvester, the at least one moisture sensor being configured to generate a moisture content signal representative of the moisture content. A controller is functionally linked with the sensor for receiving the moisture content signal, the controller being configured to generate an output signal based at least in part on the moisture content signal.

### BACKGROUND OF THE DISCLOSURE

### 1. Field of the Disclosure

The present disclosure generally relates to a harvesting machine, and more particularly to a system and method for harvesting sugarcane with a sugarcane harvesting machine.

### 2. Description of the Prior Art

Agricultural equipment, such as a tractor or a self-propelled harvester, includes mechanical systems, electrical systems, hydraulic systems, and electro-hydraulic systems, configured to prepare fields for planting or to harvest crops.

Harvesters of various configurations, including sugarcane harvesters, have harvesting systems of various types. Harvesting systems for a sugarcane harvester, for example, include assemblies or devices for cutting, chopping, sorting, transporting, etc., and otherwise gathering and processing sugarcane plants. Typical harvesting assemblies, in different implementations, include a base cutter assembly (or "base cutter"), feed rollers, cutting drums, stalk collectors, and extractor fans etc.

To actively harvest crops, the sugarcane harvester gathers and processes material from rows of sugarcane plants. In the case of one type of sugarcane harvester, the gathered sugarcane stalks are cut into billets that move through a loading elevator to an elevator discharge, where the cut sugarcane billets are discharged to a collector, such as the sugarcane wagon. Leaves, trash, and other debris are separated from the billets and ejected onto the field.

In various harvesters, harvesting assemblies are hydraulically powered by an engine-driven pump or electrically powered by a generator or other electrical power supply. The harvesting assemblies include rotating drums that move the cut stalks toward a chopper. The rotating drums are driven by a hydraulic motor or an electric motor that rotationally drives the roller to continuously move the billets to a fan for processing, and once processed, to the wagon or other transport container. The motors include splines that engage the roller to drive the roller about a rotational axis.

The sugarcane, once cut, forms what is known as a “mat” of sugarcane. The sugarcane harvester feeds the mat to a chopping section where it is chopped, including the stalk which is cut into segments. The sugarcane harvester advances the billets along with crop residue (e.g., leafy material, such as leaves, roots, and field debris etc.) to a primary extractor that separates at least a portion of the crop residue from the billets. The primary extractor includes a fan assembly having a motor and blades to clean the sugarcane, that is, to remove the crop residue from the sugarcane billets. The removed crop residue is discharged to the ground or to a collection wagon.

The primary extractor fan assembly is noted for consuming large amounts of power generated by the sugarcane harvester. For instance, currently known primary extractor fans include various inefficiencies that reduce the fans ability to efficiently use supplied power. Such inefficiencies can prevent the fan from operating efficiently under all field operating conditions. Cleaning of the sugarcane mat is highly load dependent, and is heavily affected by field conditions, such as crop density, crop moisture, and harvesting speeds, etc. These and other field conditions can affect throughput of billets through the cleaning chamber where the primary extractor fan assembly is located. Consequently, the amount of billets, as determined by the number of tons per hour, can change dramatically from field to field as well as within a field itself. Depending on the load being experienced by the primary extractor fan, the efficiency of the fan, which is dependent on fan speed and/or air flow, changes during cleaning of the incoming mat and therefore, so does the power consumption of the fan.

Depending on the efficiency of the primary extractor fan assembly, some billets are discharged at the output of the primary extractor instead of being moved to an elevator for discharge into a wagon or other container to be hauled away. In different implementations, the sugarcane harvester includes a secondary extractor that separates crop residue from the billets and discharges the separated crop residue from the sugarcane harvester. The secondary extractor includes a fan assembly having a motor and blades to discharge the crop residue from the harvester to the ground or to a collection wagon. The discharged billets are typically lost and are known as "field losses." These losses add up over the harvesting season and the amount of losses, if weighed, can be in the tons. Such losses are basically money that is left in the field.

A further issue encountered by the operator of the sugarcane harvester involves the various factors affected by the moisture content of the harvested sugarcane.

There is a continuing need for more efficient systems and methods of operating such sugarcane harvesting machinery.

### SUMMARY OF THE DISCLOSURE

The present disclosure discloses improved systems for monitoring the moisture content of the harvested sugarcane, and for improving the efficiency of the harvesting operation using the information regarding the moisture content.

In one embodiment a sugarcane harvester includes a cutter assembly for cutting stalks of the sugarcane as the harvester moves through a field. A chopper assembly is provided for chopping the cut sugarcane stalks into billets and crop residue. A primary extractor is provided for cleaning the billets and extracting the crop residue. A loading elevator transports the cleaned billets to a discharge location. At least one moisture sensor is configured to sense a moisture content of the billets as the billets move through the sugarcane harvester, the at least one moisture sensor being configured to generate a moisture content signal representative of the moisture content. A controller is functionally linked with the sensor for receiving the moisture content signal, the controller being configured to generate an output signal based at least in part on the moisture content signal.

In another embodiment a method is provided for operating a sugarcane harvester. The method includes: cutting stalks of the sugarcane as the harvester moves through a field; chopping the cut sugarcane stalks into billets and crop residue with a chopper assembly of the sugarcane harvester; cleaning the billets and extracting the crop residue with a primary extractor of the sugarcane harvester, the primary extractor including a fan; transporting the cleaned billets to a discharge location with a loading elevator of the sugarcane harvester; sensing a moisture content of the billets with at least one moisture sensor as the billets move through the sugarcane harvester, the at least one moisture sensor generating a moisture content signal representative of the moisture content; and receiving the moisture content signal with a controller and generating an output signal with the controller based at least in part on the moisture content signal

Numerous objects, features and advantages of the embodiments set forth herein will be readily apparent to those skilled in the art upon reading of the following disclosure when taken in conjunction with the accompanying drawings.

### BRIEF DESCRIPTION OF THE DRAWINGS

The above-mentioned aspects of the present disclosure and the manner of obtaining them will become more apparent and the disclosure itself will be better understood by reference to the following description of the implementations of the disclosure, taken in conjunction with the accompanying drawings.

FIG. 1 illustrates a side elevational view of a work vehicle, and more specifically, of an agricultural vehicle such as a sugarcane harvesting machine.

FIG. 2 illustrates a side sectional view of a primary extractor coupled to an elevator.

FIG. 3 shows the sugarcane harvester of FIG. 1 operating adjacent to a transport vehicle which receives the cut, chopped and cleaned sugarcane billet.

FIG. 4 is an enlarged view of a portion of the sugarcane harvester showing locations of a moisture content sensor.

FIG. 5 is a schematic drawing of the moisture content sensor.

FIG. 6 is a schematic drawing of a controller for the sugarcane harvester.

### DETAILED DESCRIPTION

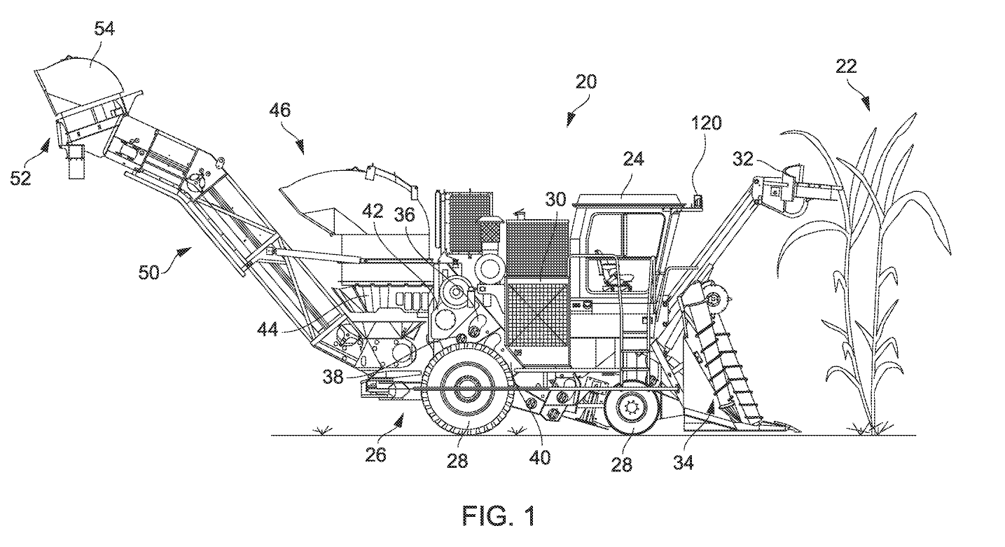

FIG. 1 illustrates a side view of a sugarcane harvester 20 adapted to cut sugarcane 22, with the front of the harvester 20 facing to the right. Accordingly, certain components of the harvester 20 may not be visible in FIG. 1. The harvester 20 includes a cab 24 located on a main frame 26 that is supported by wheels 28 configured to move the harvester along rows of sugarcane 22. An engine is located within a housing 30 that moves the wheels 28 along a field to continually cut the sugarcane 22 for harvesting. In different implementations, the engine also powers various driven components of the harvester 20. In certain implementations, the engine directly powers one or more hydraulic pumps (not shown) and other driven components powered by the hydraulic motors via an embedded hydraulic system (not shown).

A cane topper 32 extends forward of the frame 26 in order to remove the leafy tops of sugarcane plants 22. A set of crop dividers 34 guides the stalks of sugarcane toward internal mechanisms of the harvester 20 for processing. As the harvester 20 moves across a field, sugarcane plants passing between the crop dividers 34 are deflected downward by one or more knockdown rollers before being cut near the base of the plants 22 by a base cutter assembly, as would be understood by one skilled in the art. Rotating disks, guides, or paddles (not shown) on the base cutter assembly further direct the cut ends of the plants upwardly and rearward within the harvester 20 toward successive pairs of upper feed rollers 36 and lower feed rollers 38. The feed rollers 36 and 38 are supported by a feed roller chassis 40 which is supported by the main frame 26. The upper and lower feed rollers 36 and 38 convey the stalks toward a chopper drum module or chopper assembly 42 for chopping the stalks into billets.

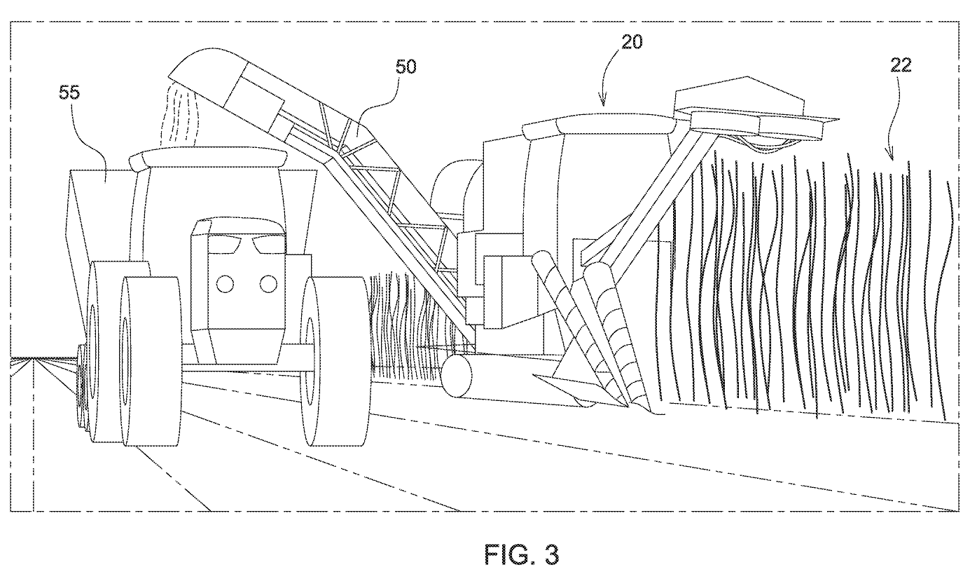

The chopper drum module 42 includes upper and lower chopper drums that rotate in opposite directions in order to chop the moving stalks into billets, as would be understood by one skilled in the art. The billets, including crop residue, are propelled into a cleaning chamber 44 that is located at the base of a primary extractor 46. The primary extractor 46, in different implementations, includes a fan assembly 64 including a powered fan to clean the billets and to extract the crop residue, trash, and debris from the cleaning chamber 44. A loading elevator 50, with a one end located at the bottom of the cleaning zone 44, conveys the cleaned billets upward to a discharge location 52, below a secondary extractor 54, where the billets are discharged into a truck, a wagon, a container, or other receptacle 55 (see FIG. 3) that collects the discharged billets. The secondary extractor 54 separates the crop residue from the cut stalk to clean the cut stalk.

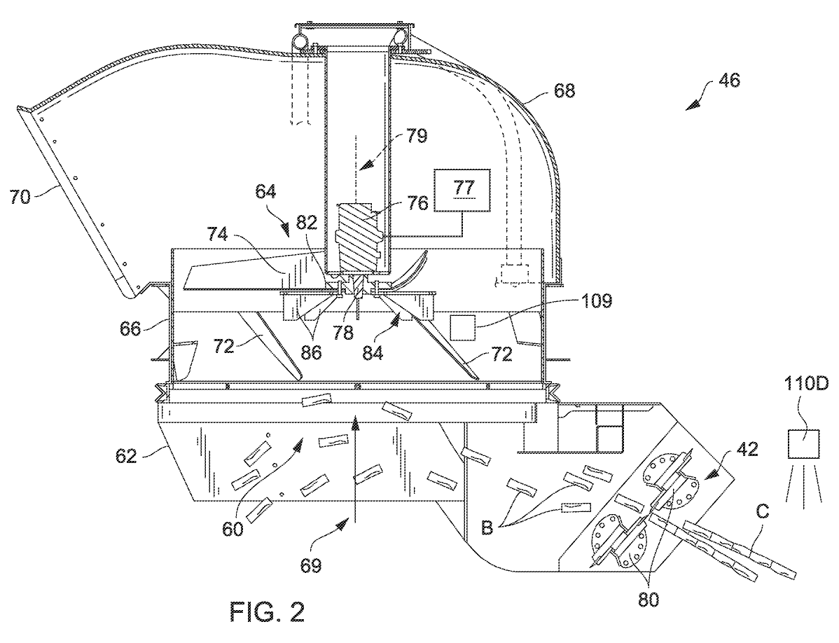

FIG. 2 illustrates a cross section through the chopper drum module 42 and the primary extractor 46. The chopper drum module 42 cuts the crop and the primary extractor 46 receives the cut crop from the chopper drum module 42 and generally separates the cut crop by way of a crop cleaner, which will be described in greater detail below. The crop cleaner may include any suitable mechanism for cleaning the cut crop, such as the fan 64 (as in the illustrated construction that will be described below), a source of compressed air, a rake, a shaker, or any other mechanism that discriminates various types of crop parts by weight, size, shape, etc. in order to separate extraneous plant matter from billets. The primary extractor 46, in different implementations, includes any combination of one or more of a cleaning chamber 60, a cleaning chamber housing 62, a crop cleaner such as a fan assembly 64, a fan enclosure 66, and an extractor hood 68 having a discharge opening 70. The fan enclosure 66 is coupled to the cleaning chamber housing 62 that in at least one implementation includes deflector vanes 72, which are fixed at a predetermined position with respect to the fan enclosure.

The fan assembly 64 includes a plurality of blades 74 driven by a fan motor 76 having a spindle 78 driving the fan blades 74. A fan speed control actuator 77 may control the speed of fan motor 76 and thus the speed of the blades 74. The angle of incidence of each of the fan blades 74 is adjustable relative an axis of rotation 79, i.e. motor axis (see FIG. 2), of the motor 76 that rotates the fan blades. The fan motor 76 drives the fan blades about the motor axis 79. As described herein, the position of the fan blades 74 with respect to the motor axis 79 of the fan motor 76 is an angle of incidence of the blades with respect to the incoming airstream. This is in contrast to the blade itself that has an inherent geometric pitch or "blade twist" which is identified from a hub of the blade to a tip of the blade. In one implementation as described herein, an airfoil type fan blade is used. Other types of blades are contemplated. Consequently, the implementations of the present disclosure include the use of different types of fan blades including but not limited to airfoil type blades (a variable pitch blade with a “twist”), variable radius blades, and constant radius blades. The angle of incidence is adjusted for all types of blades, regardless of the geometric pitch of the blade itself.

The chopper drum module 42 includes counter-rotating drum cutters 80 with overlapping blades for cutting the stalks of crop, such as cane C, into billets B, which are pieces of the stalk. In other constructions, the chopper drum module 42 includes any suitable blade or blades for cutting the stalks of crop. The crop also includes dirt, leaves, roots, and other plant matter, which will be collectively referred to herein as crop debris or crop residue, which are also cut in the chopper drum module 42 along with the cane C. The chopper drum module 42 directs a stream of the cut crop (cut stalks, or billets B, and crop debris) to the cleaning chamber 60, which is generally defined by the cleaning chamber housing 62, the fan enclosure 66, and/or the extractor hood 68

The extractor hood 68, coupled to the fan enclosure 66, includes a domed shape, or other suitable shape, and includes the opening 70 angled out from the harvester 20 and facing slightly down onto a field. In some constructions, the opening 70 is generally perpendicular to the driveshaft 78. The hood 68 directs cut crop through the opening 70 to the outside of the harvester 20, e.g., for discharging a portion of cut crop removed from the stream of cut crop back onto the field.

The fan assembly 64 of FIG. 2 is an axial flow fan which is mounted in the cleaning chamber 60 to clean the sugarcane mat by separating the cut billets from the crop debris. In one implementation, the fan assembly 64 is in the form of an extractor fan having axial flow fan blades 74 radiating out from, and joined to, a motor hub 82. In the illustrated construction, the fan assembly 64 is configured to draw air and extraneous plant matter from the cleaning chamber 60. Inlet airflow 69 generally flows into the cleaning chamber 60 generally parallel to the motor axis 79.

In other implementations, the fan assembly 64 is configured to blow rather than extract, i.e., to blow or push the air through the cleaning chamber 60 to clean the sugarcane mat by measuring leaf content and/or billet loss. The fan assembly 64, in different implementations, includes other types of fans with other types of blades, such as a centrifugal fan, amongst others. In one or more implementations, a centrifugal blower wheel 84 is mounted for rotation with the fan blades 74 and includes a plurality of generally right-angular blower blades 86 that are fixed to the underside of the centrifugal blower wheel 84 radiating out therefrom.

The motor 76, such as a hydraulic motor, includes the drive shaft 78 operatively coupled to the fan blades 74. For example, the drive shaft 78 may be keyed to the hub 82 or operatively coupled in other suitable ways to drive the fan blades 74. The motor 76, in other implementations, is operatively coupled to drive the centrifugal blower wheel 84 in a similar manner. In other implementations, the motor 76 is electric, pneumatic, or any other suitable type of motor, engine, or a prime mover, to drive the fan blades 74 and/or the centrifugal blower wheel 84.

The function of the guide vanes 72 in the fan 64, i.e. an axial flow fan, is to reduce or eliminate the air spin in the airflow entering or exiting the fan blades 74 and in return reducing the rotational energy losses. Guide vanes can be placed either on the inlet or outlet side of the airflow depending on the application and duct geometry. As seen in FIG. 2, the guide vanes are located on the inlet side.

### Moisture Sensors:

The present disclosure is directed to the use of one or more moisture sensors 110 to sense a moisture content of the billets B as they billets B move through the sugarcane harvester 20.

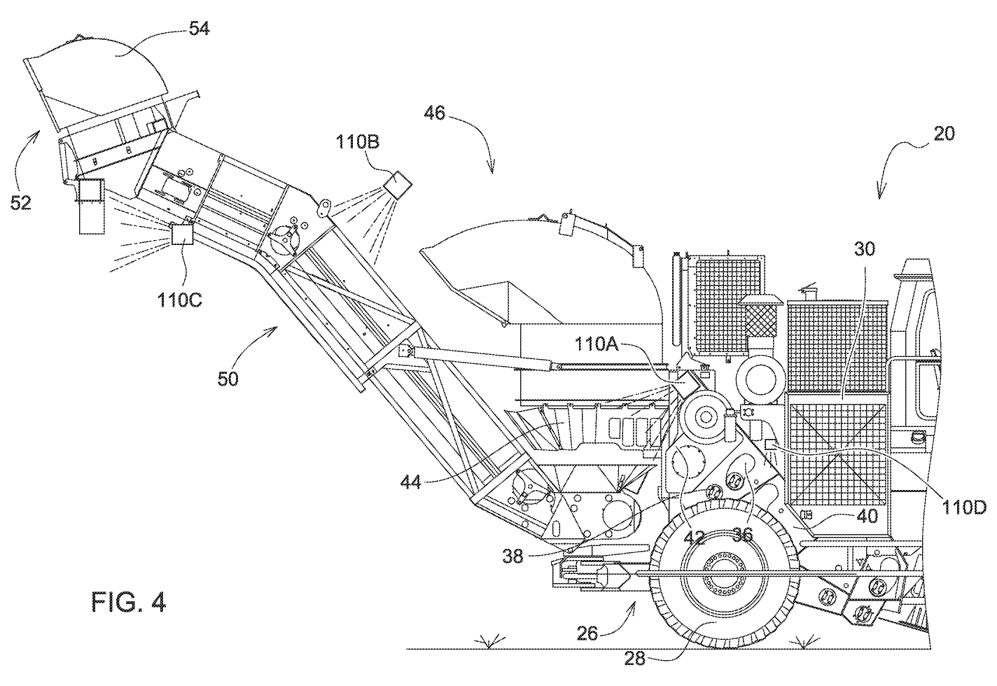

FIG. 4 is an enlarged view of a portion of the sugarcane harvester 20 including the primary extractor 46, the loading elevator 50 and the secondary extractor 54. Several suitable locations for the moisture sensor 110 are shown. Moisture sensor 110A is shown as being located below the primary extractor 46. Moisture sensor 110B is shown as being located along the loading elevator 50. Moisture sensor 110C is shown as being located below the secondary extractor 54. Moisture sensor 110D is shown as being located upstream of the chopper assembly 42 in the area of the feed rollers that feed the sugarcane mat to the chopper assembly 42. Although the moisture sensors 110A, 110B, 110C and 110D are only schematically shown in FIG. 4, without any details of the structural supports for the sensors, it will be understood that each moisture sensor will be supported via appropriate brackets from the other structural features of the sugarcane harvester 20.

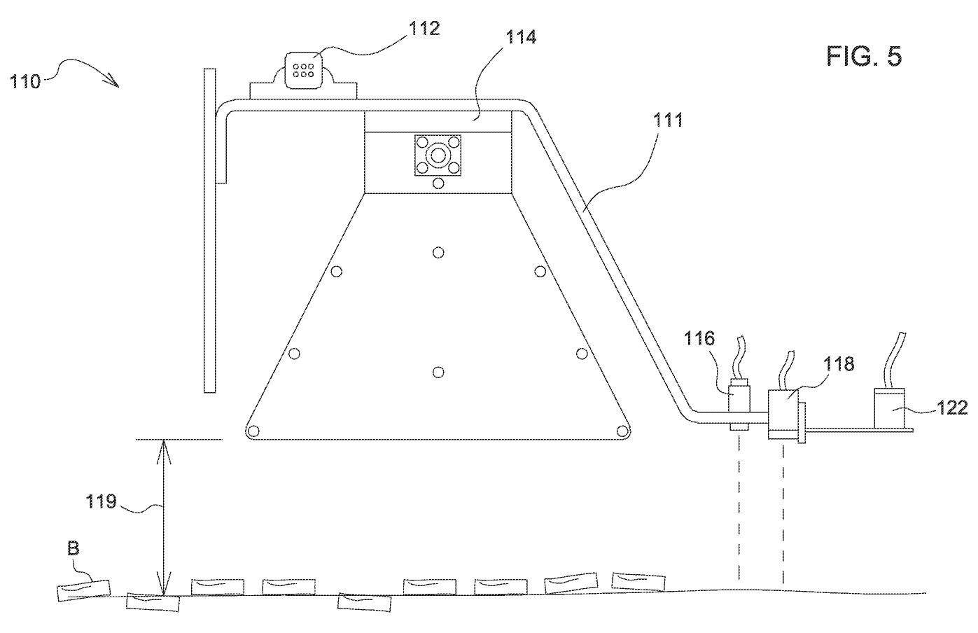

FIG. 5 is a schematic illustration of one of the moisture sensors 110 relative to the matt of sugarcane billet B being observed with the sensor 110. The moisture sensor 110 may include one or more radio frequency directional antenna units 114 mounted on a housing or bracket 111. The one or more directional antenna units 114 may include one antenna unit configured to emit radio frequency (RF) energy and one antenna unit configured to receive the reflected RF energy reflected from the billets B, or it may include a single antenna unit which both transmits and receives radio frequency energy. The housing 111 may be supported from any appropriate structure of the harvester 20. Other parameter sensors associated with the moisture sensor 110 may also be mounted on the housing 111. These other parameter sensors may include inertial measurement unit (IMU) 112, temperature sensor 116, range finding sensor 118 and billet speed sensor 122, all of which are further described below.

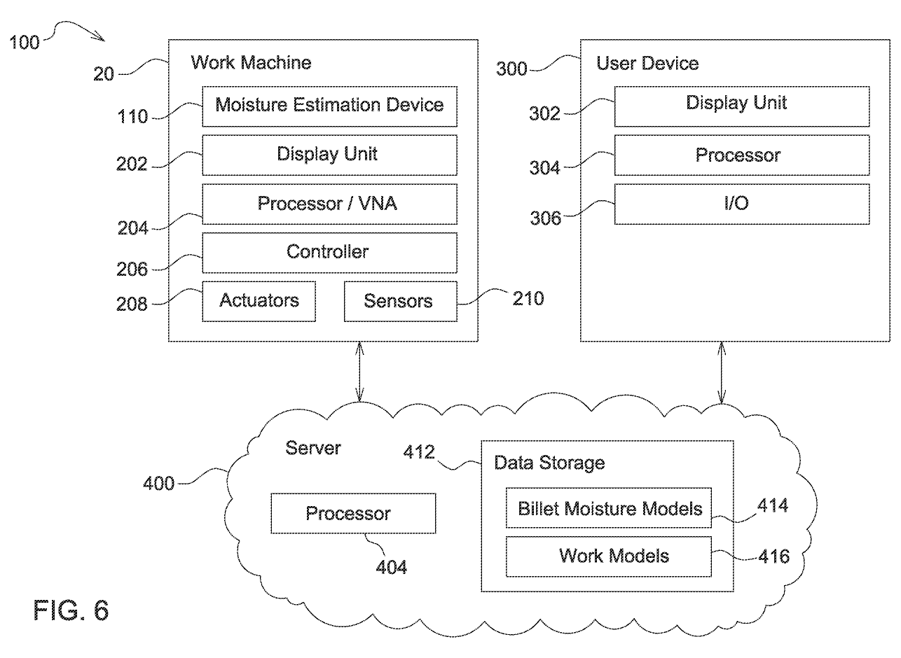

FIG. 6 schematically illustrates a billet moisture estimation system 100 for performing operations and methods as further disclosed herein, which may include the work machine 20, one or more mobile computing or other user devices 300, and a remote server 400. In some embodiments, a system and method according to the present disclosure may be self-contained with respect to the work machine 20.

The work machine 20 may further include a display unit 202, for example associated with a local user interface for input/output with respect to a controller 206, various actuators 208, and sensors 210. In various embodiments, the display unit 202 may include a LCD display, a LED display, an OLED display, touch display, or other suitable user interface. The controller 206 may include or otherwise functionally communicate with a vector network analyzer (VNA) 204 or equivalent for implementing the non-contact moisture estimation operations and methods as disclosed herein. The VNA 204 may for example perform radio frequency front-end functionality, for example the measurement of sample scattering parameters, which is then digitized and processed, locally or subsequent to transmission to a downstream processing unit such as controller 206 or the like. Alternatively, the controller 206 may include or otherwise functionally communicate with a Controller Area Network (CAN) as a communication protocol for implementing the non-contact moisture estimation operations and methods as disclosed herein.

In an exemplary but non-limiting embodiment, VNA 204 may have an available range of 300kHz to 9GHz, although preferably only a subset of the available frequency range may be utilized during operation as further described below and is connected to one or more directional antennas or radio antenna units 114 using conventional media such as a coaxial transmission line.

The controller 206 may be part of a machine control system of the working machine, or it may be a separate control module. The controller 206 in the present embodiment is configured to receive input signals from some or all of sensors 210. Various of the sensors 210 may typically be discrete in nature, but signals representative of more than one input parameter may be provided from the same sensor, and one or more sensors 210 as disclosed herein may further include or otherwise refer to signals provided from the machine control system.

The sensors 210 may include sensors associated with the moisture estimation device 110, for example mounted on a housing 111 associated with the device 110 and not directly to the work machine 20 but functionally linked to the VNA 204 and optionally in communication with the controller 206 (if separate). In an embodiment as illustrated in FIG. 5, such sensors may include an inertial measurement unit (IMU) 112, the one or more directional antennas or radio antenna units 114, a temperature sensor 116, a range finding sensor 118, and a billet speed sensor 122. The temperature sensor 116 may detect a temperature of the billets B of the sugarcane mat flowing through the sugarcane harvester. The range finding sensor 118 may detect a distance 119 of the antenna 114 from the billets B. The one or more directional antenna units 114 may include one antenna unit 114A configured to emit radio frequency (RF) energy and one antenna unit 114B configured to receive the reflected RF energy reflected from the billets B. The billet speed sensor 122 may detect a speed of the billets B which may be referred to as a movement characteristic of the billets B.

In an embodiment wherein the moisture estimation device 110 is configured to perform moisture analysis without reliance on a controller 206 of the work machine 20, or at least to perform a portion of the moisture analysis in combination with the controller 206 of the work machine 20, the device 110 may include a controller/ processor comprising or otherwise associated with the VNA 204.

In an embodiment the sensors 210 may include machine position determining sensors such as a separate IMU mounted on the work machine 20 itself, and/or a global positioning system (GPS) transceiver 120 mounted on machine 20 (see FIG. 1), ground speed sensors, steering sensors, or the like, or equivalent inputs from the machine control system.

In an embodiment, sense elements from an IMU 112 mounted on the housing 111 of the device 110 may be fused with sense elements from IMU mounted on the work machine 20 or other position and/or orientation related inputs in an independent coordinate frame associated at least in part with the respective work machine 20.

The controller 206 of the work machine 20 may in some embodiments further receive inputs from and generate outputs to remote user devices 300 associated with a user via a respective user interface, for example a display unit 302 with touchscreen interface and associated input/output devices 306 and functionality. Data transmission, between for example a vehicle control system and a remote user interface, may take the form of a wireless communications system and associated components as are conventionally known in the art. In certain embodiments, a remote user interface and vehicle control systems for respective work machines 20 may be further coordinated or otherwise interact with a remote server 400 or other computing device for the performance of operations in a system 100 as disclosed herein.

The controller 206 may be configured to generate control signals for controlling the operation of respective actuators 208 of the work machine of FIGS. 1 and 2. The controller 206 may generate signals for indirect control of relevant actuators 208 via intermediate control units, associated with for example a machine steering control system, a machine implement control system, an engine speed control system, etc. Such control systems may be independent or otherwise integrated together or as part of a machine control unit in various manners as known in the art.

The controller 206 may include, or be associated with, the processor 204, as well as a computer readable medium, a communication unit, data storage such as for example a database network (not shown), and the aforementioned display unit 202 comprising or otherwise associated with a user interface or control panel. An input/output device, such as a keyboard, touch screen, or other user interface tool may be coupled to the controller 206 via the user interface so that the human operator may input instructions to the controller 206.

It is understood that the controller 206 described herein may be a single controller having all of the described functionality, or it may include multiple controllers wherein the described functionality is distributed among the multiple controllers.

Various “computer-implemented” operations, steps or algorithms as described in connection with the controller 206 or alternative but equivalent computing devices or systems can be embodied directly in hardware, in a computer program product such as a software module executed by the processor 204, or in a combination of the two. The computer program product can reside in RAM memory, flash memory, ROM memory, EPROM memory, EEPROM memory, registers, hard disk, a removable disk, or any other form of computer-readable medium known in the art. An exemplary computer-readable medium can be coupled to the processor 204 such that the processor 204 can read information from, and write information to, the memory/storage medium. In the alternative, the medium can be integral to the processor 204. The processor 204 and the medium can reside in an application specific integrated circuit (ASIC). The ASIC can reside in a user terminal. In the alternative, the processor 204 and the medium can reside as discrete components in a user terminal.

The term “processor” 204 as used herein may refer to at least general-purpose or specific-purpose processing devices and/or logic as may be understood by one of skill in the art, including but not limited to a microprocessor, a microcontroller, a state machine, and the like. A processor 204 can also be implemented as a combination of computing devices, e.g., a combination of a digital signal processor (DSP) and a microprocessor, a plurality of microprocessors, one or more microprocessors in conjunction with a DSP core, or any other such configuration.

The communication unit may support or provide communications between the controller 206 and external systems or devices, and/or support or provide communication interface with respect to internal components of the self-propelled work machine 20. The communications unit may include wireless communication system components (e.g., via cellular modem, WiFi, Bluetooth, or the like) and/or may include one or more wired communications terminals such as universal serial bus ports.

The data storage as further described below may, unless otherwise stated, generally encompass hardware such as volatile or non-volatile storage devices, drives, memory, or other storage media, as well as one or more databases residing thereon.

As noted above, various operations as disclosed herein, for example relating to non-contact moisture content estimation for the billets B, may be executed via a controller 206 for a given work machine 20, wherein the controller may be a discrete device or integrated with a vehicle control system or equivalent. In various embodiments as initially noted above operations may further or in the alternative be executed via a distributed system 100 including one or more remote processors 304, 404, such as for example are associated with hosted servers 400 in a cloud computing platform or mobile user devices 300, independently or in association with a local controller 206 for each work machine 20.

Each remote processor 304, 404 may be respectively or collectively associated with hosted cloud data storage 412 or distributed/ third party data storage having for example billet moisture models 414, work models 416 relating to electronic worksite maps, planning information, work machine information, and the like retrievably stored thereon and collectively accessible for execution of operations and methods as disclosed herein.

The moisture sensors 110A, 110B, 110C, may be described as at least one moisture sensor 110 configured to sense a moisture content of the billets B as the billets B move through the sugarcane harvester 20, the at least one moisture sensor 110 being configured to generate a moisture content signal representative of the moisture content of the billets B. The controller 206 and/or remote processor 304, 404 may be described as a controller functionally linked with the moisture sensor 110 for receiving the moisture content signal, the controller being configured to generate an output signal or output command based at least in part on the moisture content signal.

The other sensors 210 such as temperature sensor 116, range finding sensor 118, and billet speed sensor 122 may be referred to as one or more parameter sensors 116, 118, 122 configured to generate parameter output signals representing operational parameters relating to the billets B. Temperature sensor 116 detects temperature of the billets B. Range finding sensor 118 detects the distance 119 of the moisture sensor 110 from the billets B. The billet speed sensor 122 detects the speed at which the billets B are passing by the moisture sensor 110.

The controller 206 and/or remote processor 304, 404 may be described as a controller functionally linked with one or more of the parameter sensors 116, 118, 122. The controller 206 and/or remote processor 304, 404 are configured to estimate at least one moisture condition for the billets B based at least in part on the parameter output signals and the moisture content signal. The controller 206 and/or remote processor 304, 404 are configured to estimate the at least one moisture condition based on modelled correlations between the at least one moisture condition and inputs including the sensed parameters detected by parameter sensors 116, 118, 122, and the reflected energy detected by the moisture sensor(s) 110. The at least one moisture condition may include: internal moisture content of the billets; external moisture content of the billets; or combined internal and external moisture content of the billets.

The controller 206 and/or remote processor 404 are configured to generate the output signal based at least in part on the moisture content signal.

The output signal may be configured to actuate at least one actuator to adjust at least one operating parameter of the sugarcane harvester based at least in part on the moisture content signal. The at least one actuator may include a fan speed control actuator 77 of the primary extractor 46.

### Methods of the Disclosure:

A method of operating the sugarcane harvester 20 may be described as including:

cutting stalks C of the sugarcane 22 as the harvester 20 moves through a field;

chopping the cut sugarcane stalks C into billets B and crop residue with the chopper assembly 42 of the sugarcane harvester 20;

cleaning the billets B and extracting the crop residue with the primary extractor 46 of the sugarcane harvester 20, the primary extractor 46 including the fan 64;

transporting the cleaned billets B to a discharge location with the loading elevator 50 of the sugarcane harvester 20;

further cleaning the billets B with the secondary extractor 54 of the sugarcane harvester 20 before the billets B are discharged from the loading elevator 50;

sensing a moisture content of the billets B with at least one moisture sensor 110 as the billets B move through the sugarcane harvester 20, the at least one moisture sensor 110 generating a moisture content signal representative of the moisture content; and

receiving the moisture content signal with a controller 206, 304, 404 and generating an output signal with the controller 206, 304, 404 based at least in part on the moisture content signal.

The output signal generated by the controller 206 and/or remote processor 404 may be used in several different ways.

### Use of Calibration Factor for Truck Loading:

The output signal generated by the controller 206 and/or remote processor 304, 404 may include a calibration factor representative of a change in moisture content relative to a base calibration value.

The base calibration value may for example be determined in the following manner. A known volume of billet material B may be run through the sugarcane harvester 20 and its moisture content detected by the moisture sensor 110. That known volume may then be weighed and the moisture content signal generated by the moisture sensor 110 may be recorded as the base calibration value associated with the measured weight for the known volume of billet material. Then as the sugarcane harvesting operation continues, changes in the moisture content signal as compared to the base calibration value may be interpreted as corresponding to a change in moisture content of the billets and a corresponding change in weight of the billets per unit volume. Multiple calibration trials may be run at different moisture content levels to generate a database or algorithm showing the correspondence between the moisture content signal and the weight per unit volume of the billets B. The output signal generated by the controller 206 and/or remote processor 304, 404 based on the moisture content signal, and also possibly based on the various other operating parameters of the sugarcane harvester, may be described as being a calibration factor representative of a change in moisture content relative to the base calibration value. Such a base calibration value may be determined once for a given field, and recalibration may only be required if there is a substantial change in field conditions.

The billets B may be discharged from the sugarcane harvester 20 into the truck, wagon or other container 55. The weight of the load of sugarcane billet in the container may then be estimated based at least in part on the calibration factor.

This allows a more accurate estimate of the actual weight of the container 55 to be made. It will be appreciated that this is of great value to the operator of the transport truck or other container 55, especially in a situation where there are legal load limits for the truck and corresponding financial penalties for moving an overweight truck over the public highways. In many situations no facility is immediately available in the field to actually weigh the truck, so the weight is estimated based on the observed loading level in the truck and prior knowledge of the estimated weight of that volume of material. In the past a truck operator might only load their truck to perhaps 95% of the estimated maximum legal load, due to uncertainty about the actual weight of the load due to the variable moisture content of the load. With the present system, a more accurate estimate of the actual weight of the load may be made using the calibration factor based on the detected moisture content of the billet as it is being loaded. Thus the truck operator can more precisely estimate the actual weight of the load, and load more closely to a 100% of legal limit with less risk of an inadvertent overloading situation.

### Control of Harvester Operating Parameters:

Another use of the output signal generated by the controller 206 and/or remote processor 304, 404 is to control various actuators controlling operating parameters of the sugarcane harvester 20 to improve various aspects of that operation.

For example, the primary extractor 46 may include a control system feature for optimizing the cleaning of the billets B so as to insure maximum cleaning without loss of billet B into the stream of ejected crop residue. One such control system is marketed by Deere & Company, the assignee of the present application, as its “SmartClean” system. One example of such a system is described in U.S. Patent No. 10,091,934, the details of which are incorporated herein by reference.

Such an automated billet cleaning system may include sensors detecting a cleaning level achieved, such as a sensor detecting billet B being lost in the ejected crop residue stream exiting the exit 70 of primary extractor 46. The control system may then control the speed of the fan motor 76 to reduce the fan speed if excess billet B is detected as being lost in the ejected crop residue stream. Various other measured parameters, in addition to billet loss, may be monitored and included in the control algorithm for such a system.

By including the moisture sensor 110 disclosed in the present disclosure, such an extractor control system may take changing moisture content into account when determining the optimum fan speed, and then the fan speed control actuator 77 may adjust the fan speed of fan motor 76 at least in part based on the moisture content signal and the corresponding control signal from the controller 206 and/or remote processor 304, 404. If the moisture sensor detects a decrease in moisture content, and thus a reduced weight of the crop residue to be transported by the fan assembly 64, the fan speed may be correspondingly reduced without decreasing quality of the produced billets B. Similarly, an increase in detected moisture content may require an increase in fan speed.

### Crop Health Indicator:

A further use which may be made of the output signal generated by the controller 206 and/or remote processor 304, 404 is to document and report one or more crop health parameters. The output signal may include a crop health indicator corresponding to one or more crop health parameters indicative of the health of the sugarcane in the field.

For example, Deere & Company, the assignee of the present application, provides a service to its customers known as the John Deere “OPERATIONS CENTER” where information from the customer’s agricultural machines is downloaded and used to generate reports to assist the customer in making planning decisions for their agricultural operation.

The moisture content signal generated by the moisture sensors 110 and/or the corresponding output signal generated by the controller 206 and/or remote processor 304, 404 based on that moisture content signal may be recorded and correlated with the geographic location of the sugarcane harvester 20 within the customer’s field. A new data layer describing water uptake of the cane with respect to other parameters such as ground moisture, canopy temperature, yield, etc. may be generated.

Thus, it is seen that the apparatus and methods of the embodiments disclosed herein readily achieve the ends and advantages mentioned as well as those inherent therein. While certain preferred embodiments have been illustrated and described for purposes of the present disclosure, numerous changes in the arrangement and construction of parts and steps may be made by those skilled in the art, which changes are encompassed within the scope and spirit of the present disclosure as defined by the appended claims.

What is claimed is:

1. A sugarcane harvester, comprising:
a cutter assembly for cutting stalks of the sugarcane as the harvester moves through a field;
a chopper assembly for chopping the cut sugarcane stalks into billets and crop residue;
a primary extractor for cleaning the billets and extracting the crop residue;
a loading elevator for transporting the cleaned billets to a discharge location;
at least one moisture sensor configured to sense a moisture content of the billets as the billets move through the sugarcane harvester, the at least one moisture sensor being configured to generate a moisture content signal representative of the moisture content; and
a controller functionally linked with the sensor for receiving the moisture content signal, the controller being configured to generate an output signal based at least in part on the moisture content signal.

2. The sugarcane harvester of claim 1, wherein:
the at least one moisture sensor includes a moisture sensor located below the primary extractor.

3. The sugarcane harvester of claim 1, wherein:
the at least one moisture sensor includes a moisture sensor located along the loading elevator.

4. The sugarcane harvester of claim 1, further comprising:
a secondary extractor for further cleaning the billets before the billets are discharged from the loading elevator; and
wherein the at least one moisture sensor includes a moisture sensor located below the secondary extractor.

5. The sugarcane harvester of claim 1, wherein:
the at least one moisture sensor includes at least one radio antenna unit configured to receive reflected energy from the billets as the billets move through the sugarcane harvester.

6. The sugarcane harvester of claim 5, wherein:
the at least one radio antenna unit is configured to emit energy and to receive the reflected energy.

7. The sugarcane harvester of claim 5, wherein:
the at least one radio antenna unit includes a first radio antenna unit configured to emit energy and a second radio antenna unit configured to receive the reflected energy.

8. The sugarcane harvester of claim 1, further comprising:
one or more parameter sensors configured to generate parameter output signals representing parameters including a temperature, one or more movement characteristics of the billets, and a distance between the at least one moisture sensor and the billets; and
wherein the controller is functionally linked to the one or more parameter sensors and is configured to estimate at least one moisture condition for the billets based at least in part on the parameter output signals and the moisture content signal.

9. The sugarcane harvester of claim 8, wherein:
the controller is configured to estimate the at least one moisture condition based on modelled correlations between the at least one moisture condition and inputs including the sensed parameters and the moisture content signal.

10. The sugarcane harvester of claim 1, wherein:
the output signal is configured to actuate at least one actuator to adjust at least one operating parameter of the sugarcane harvester based at least in part on the moisture content signal.

11. The sugarcane harvester of claim 10, wherein:
the at least one actuator includes a fan speed control of the primary extractor.

12. The sugarcane harvester of claim 1, wherein:
the output signal includes a calibration factor representative of a change in moisture content relative to a base calibration value.

13. The sugarcane harvester of claim 1, wherein:
the at least one moisture sensor includes a moisture sensor located upstream of the chopper assembly.

14. A method of operating a sugarcane harvester, comprising:
cutting stalks of the sugarcane as the harvester moves through a field;
chopping the cut sugarcane stalks into billets and crop residue with a chopper assembly of the sugarcane harvester;
cleaning the billets and extracting the crop residue with a primary extractor of the sugarcane harvester, the primary extractor including a fan;
transporting the cleaned billets to a discharge location with a loading elevator of the sugarcane harvester;
sensing a moisture content of the billets with at least one moisture sensor as the billets move through the sugarcane harvester, the at least one moisture sensor generating a moisture content signal representative of the moisture content; and
receiving the moisture content signal with a controller and generating an output signal with the controller based at least in part on the moisture content signal.

15. The method of claim 14, further comprising:
performing a base calibration to determine a base calibration value of the moisture content signal corresponding to a base condition; and
wherein the output signal includes a calibration factor representative of a change in moisture content relative to the base calibration value.

16. The method of claim 15, further comprising:
discharging the cleaned billets to a transport container; and
estimating a weight of a load of sugarcane billet in the container based at least in part on the calibration factor.

17. The method of claim 15, further comprising:
actuating at least one actuator and thereby adjusting at least one operating parameter of the sugarcane harvester based at least in part on the moisture content signal.

18. The method of claim 17, wherein:
the at least one actuator includes a fan speed control of the primary extractor and the fan speed of the primary extractor is adjusted based at least in part on the moisture content signal.

19. The method of claim 15, wherein:
the output signal from the controller includes a crop health indicator corresponding to one or more crop health parameters indicative of the health of the sugarcane in the field.
